(19) United States
(12) Patent Application Publication
(10) Pub. No.: US 2013/0162643 A1
(43) Pub. Date: Jun. 27, 2013

(54) Physical Three-Dimensional Model Generation Apparatus

(71) Applicant: Marc Cardle, London (GB)

(72) Inventor: Marc Cardle, London (GB)

(21) Appl. No.: 13/820,256

(22) PCT Filed: Aug. 25, 2011
(86) PCT No.: PCT/GB2011/051603

§ 371 Date: Mar. 1, 2013

(30) Foreign Application Priority Data
Sep. 3, 2010 (GB) 1014643.9

(51) Int. Cl. G06T 17/00

(52) U.S. Cl. CPC G06T 17/00
USPC 345/420

(57) ABSTRACT

A modeling apparatus is described comprising an input buffer (20) operable to receive image data (12) representing an image of one or more objects (14) from a viewpoint; an image processor (22) operable to determine relative depths of portions objects appearing in the image (12) as viewed from the viewpoint; a depth map generator (26) operable to assign portions of an image (12), depth data on the basis of relative depths determined by the image processor (22); and a controller (30) operable to generate instructions to control a machine tool to generate a three dimensional relief (40) of an image on the basis of depth data assigned to portions of an image by the depth map generator (26) and color the generated relief utilizing received image data (12).

### FIELD OF THE INVENTION

The present application concerns relief model generation apparatus and methods for generating relief models. More specifically, the present application concerns relief model generation apparatus and methods for generating relief models from images.

### BACKGROUND TO THE INVENTION

Although photographs can provide an excellent record of an image or event, as photographs are flat images they are limited as to how they convey an impression of a three dimensional scene.

One approach to address this limitation is to process one or more two-dimensional images and create a physical three dimensional model based on the images.

U.S. Pat. No. 5,764,231 is an example of a system for generating physical three-dimensional models from a set of images. In U.S. Pat. No. 5,764,231 images are obtained from a plurality of different viewpoints. The images are then processed to generate a three-dimensional computer model of an imaged object. The three-dimensional computer model is then used to create a physical replica of the original object. Other similar prior art systems for generating three-dimensional models from images include U.S. Pat. No. 5,926,388 which discloses a method and system for producing a three-dimensional image of a person's head and US2008148539 in which a three-dimensional image is used to generate a three-dimensional pattern, which in turn is used to generate a mold cavity.

Such prior art system, do however suffer from a number of limitations. In order to generate complete 3D data for an object it is necessary to obtain images of the object from multiple viewpoints. Multiple images are also required to determine texture render data for those parts of an object which are obscured in individual images. This greatly increases the complexity of the equipment necessary to create a replica of an object.

Further existing 3D modeling systems can only create models of individual objects. In the process of creating such models the context of an object is lost. As such the modeling systems lack the versatility of photographs which can capture an entire scene illustrating objects within a specific context.

An alternative approach is therefore desirable.

### SUMMARY OF THE INVENTION

In accordance with one aspect of the present invention there is provided a relief model generation method comprising: obtaining image data representing an image of one or more objects from a viewpoint; determining relative depths of portions of objects appearing in the image as viewed from the viewpoint; assigning portions of the image depth data on the basis of said determination of relative depths; controlling a machine tool utilizing the assigned depth data to generate a three dimensional relief of the obtained image; and coloring the generated relief using the obtained image data.

Determining relative depths of portions of objects appearing in an image may comprise processing obtained image data to generate a three dimensional computer model of objects in the image and utilizing the generated three dimensional computer model to determine the relative depths of portions of objects appearing in the image as viewed from the viewpoint.

In some embodiments processing obtained image data to generate a three dimensional computer model of objects in an image may comprise storing a three dimensional computer model of objects corresponding to a least part of the obtained image and utilizing the stored computer model to assign depth data to the portions of the image corresponding to the stored computer model.

In such an embodiment the method may further comprise identifying portions of an obtained image which do not correspond to the stored three dimensional computer model and generating a three-dimensional computer model of the portions of an obtained image which do not correspond to the stored three dimensional computer model and utilizing the generated computer model to assign depth data to the generated computer model.

In some embodiments, determining relative depths of portions of objects appearing in an image may comprise obtaining image data of the one or more objects appearing in an image from a plurality of viewpoints and utilizing said image data to generate a three-dimensional model of one or more objects appearing in the image.

Determining relative depths of portions of objects appearing in an image as viewed from a viewpoint may comprise determining the distance between of portions of objects appearing in an image and a viewpoint. Depth data may then be assigned to portions of an image on the basis of the determined distances. In some embodiments the same depth data may be assigned to all portions of an image determined to be in specified ranges of distances from the viewpoint.

In accordance with a further aspect of the present invention there is provided a modeling apparatus comprising: an input buffer operable to receive image data representing an image of one or more objects from a viewpoint; an image processor operable to determine relative depths of portions objects appearing in the image as viewed from the viewpoint; a depth map generator operable to assign portions of an image, depth data on the basis of relative depths determined by the image processor; and a controller operable to generate instructions to control a machine tool to generate a three dimensional relief of an image on the basis of depth data assigned to portions of an image by the depth map generator and color the generated relief utilizing received image data.

### BRIEF DESCRIPTION OF THE DRAWINGS

Embodiments of the present invention will now be described with reference to the accompanying drawings in which:

FIG. 1 is a schematic block diagram of a relief model generation apparatus in accordance with a first embodiment of the present invention;

FIG. 2 is a flow diagram of the processing of the relief model generation apparatus of FIG. 1.

FIG. 3 is a schematic block diagram of a relief model generation apparatus in accordance with a second embodiment of the present invention; and

FIG. 4 is a schematic block diagram of a relief model generation apparatus in accordance with a third embodiment of the present invention.

### SPECIFIC EMBODIMENTS

### First Embodiment

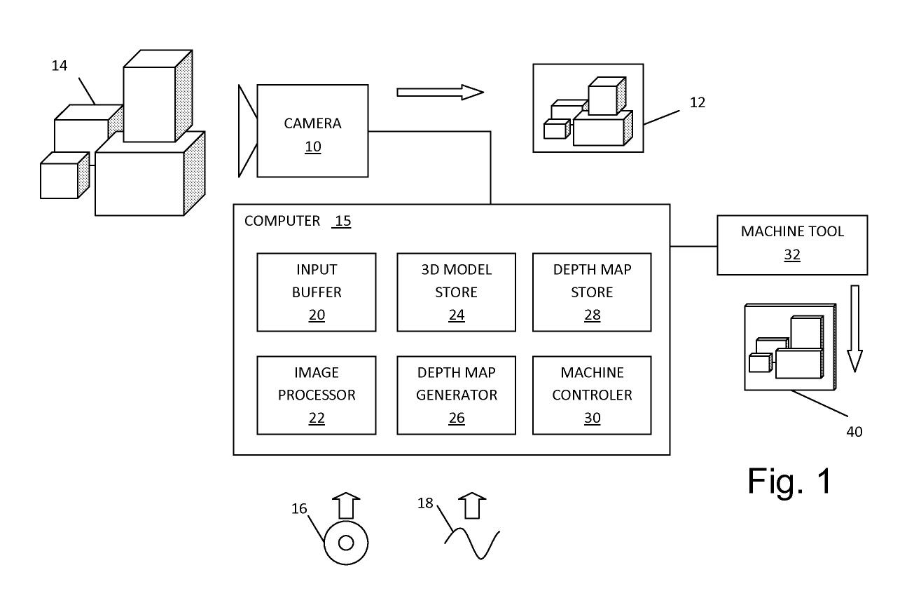

Referring to FIG. 1, a camera 10 is provided which is arranged to obtain an image 12 of one or more objects 14 from a viewpoint. Image data representing the image 12 of the objects 14 is passed from the camera 10 to a computer 15 attached to the camera 10. The computer 15 is configured by processing instructions either stored on a disk 16 or by receiving a signal 18 via a communications network into a number of functional blocks 20-30. These functional blocks 20-30 enable the computer 15 to process the image data 12 to generate instructions for causing a machine tool 32 to create a colored three dimensional relief 40 corresponding to the obtained image 12.

More specifically the instructions generated by the computer 15 are such to create a colored three dimensional relief 40 of the obtained image where the variation in the upper surface of the relief is such so that the relative positioning of portions of the relief 40 correspond to the relative distances between the viewpoint from where an image is obtained and the visible portions of objects appearing in an obtained image 12. That is to say those portions of the generated relief 40 which correspond to objects closer to the viewpoint correspond to raised portions of the relief 40 and more distant objects correspond to recessed portions of the relief. A relief model of the image can then be generated by then coloring the surface of the relief 40 in a manner corresponding to the obtained image 12. Such a relief model will correspond to the image 12 but to the variation is surface height will give an enhanced impression of the three-dimensional features appearing in the image 12.

In this embodiment the functional blocks 20-30 into which the memory of the computer 15 becomes configured comprise: an input buffer 20 for receiving image data 12 corresponding to an image taken by the camera 10; an image processor 22 operable to process received image data to determine the relative positioning of objects appearing in a received image 12 and generate and store a 3D model of the imaged objects in a 3D model store 24; a depth map generator 26 operable to process 3D model data stored in the 3D model store 24 and associate portions of a received image with depth data; a depth map store 28 operable to store depth data generated by the depth map generator 26; and a machine controller 30 operable to utilize image data 12 stored in the input buffer 20 and a depth map stored in the depth map store 28 to generate control instructions for the machine tool 32 to cause the machine tool 32 to form and color a relief 40 corresponding to a received image 12.

It will be appreciated that these described functional modules 20-30 are nominal in nature and may or may not correspond directly to blocks of code or software instructions or specific blocks of memory in the computer 15. Rather it will be appreciated that these described functional modules 20-30 are merely illustrative in nature and that in certain embodiments the described modules may be combined or sub-divided and that actual blocks of code may be involved in the processing of multiple modules.

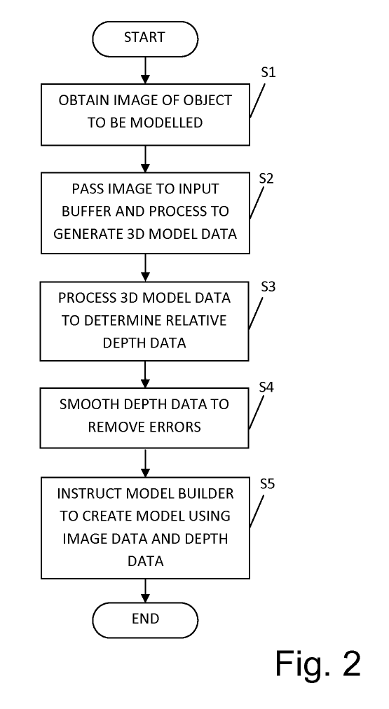

The processing of the apparatus in accordance with the present embodiment will now be described in greater detail with reference to FIG. 2 which is a flow diagram of the processing undertaken to create a relief from an image.

Turning to FIG. 2 as an initial step (s1) an image of an object to be modeled is obtained in a conventional manner using the camera 10.

Typically the camera 10 used will be a digital camera in which images comprise a large number of pixels where each pixel is associated with a set of three numbers identifying red green and blue color values where 0,0,0 identifies a black pixel and 255, 255, 255 identifies a bright white pixel. As an alternative if an image is obtained using an analogue camera a similar result can be achieved by scanning an obtained image using a digital scanner to convert the obtained image 12 into digital image data. It will be appreciated that in such alternative embodiments image data could also be obtained in other ways such as directly scanning an image without obtaining an analogue image.

Once an image 12 of the objects 14 to appear in a relief 40 has been taken using the camera 10, it is then transferred (s2) and stored in the input buffer 20 and then the image processor 22 is then invoked to process the stored image data and to generate a computer model of the objects appearing in the obtained image 12.

In this embodiment, the image processor 22 processes a single image to generate a three-dimensional computer model of objects appearing in the image using conventional techniques. Suitable techniques would include such defocusing techniques and calculating a second Gaussian derivative such as is described in Wong, K. T.; Ernst, F. (2004), Master thesis “Single Image Depth-from-Defocus”, Delft university of Technology & Philips Natlab Research, Eindhoven, The Netherlands; processing the image to determine linear perspectives to identify vanishing lines and assign gradient planes to the image as is described in Battiato, S. ; Curti, S.; La Cascia, M.; Tortora, M.; Scordato, E. (2004) “Depth map generation by image classification”, SPIE Proc. Vol. 5302, EI2004 conference ‘Three dimensional image capture and applications VI”; processing an image based on atmosphere scattering or shading such as is described in Cozman, F.; Krotkov, E. (1997) “Depth from scattering”, IEEE Computer society conference on Computer Vision and Pattern Recognition, Proceedings, Pages: 801-806 or Kang, G; Gan, C.; Ren, W. (2005), “Shape from Shading Based on Finite-Element”, Proceedings, International Conference on Machine Learning and Cybernetics, Volume 8, Page(s): 5165-5169 all of which are hereby incorporated by reference. Other similar techniques which may be utilized to generate suitable model data could also include identification of occlusion in the image either using curvature smoothing and isophotes such as described in WO2005091221 and or determining appropriate shortest path transforms such as is discussed in WO2005083630 and WO2005083631 all of which are hereby incorporated by reference.

Another approach would be to use supervised learning methods such as that described in US2008/137989 which is also incorporated by reference, which makes use of training data library with the ground truth measurements of real-world 3D scans. Such an approach looks at how those measurements relate to local and global image features such as texture variations, texture gradients, haze (atmosphere scattering) and/or image features extracted at multiple image scales. This would then used to model the conditional distribution of depth at each point in an unseen image.

It will be appreciated that the specific approaches which will best suit a particular image will depend upon the nature and content of the image which is to be processed. Using any or a combination of the above techniques a 3D model of the objects appearing in an obtained image can be generated and the resultant model is then stored in the 3D model store 24. In this embodiment the model data is stored in a form of a distance map which is a matrix of numbers corresponding to each of the pixels in the obtained image 12 where each of the numbers identifies the distance between a reference plane, being a plane corresponding to projection of the image, and the surface that has been determined for that pixel in the image. Where distance data is not available for a particular portion of an image, in this embodiment, a null value is included in the matrix indicating as a default that the point in question is to be considered to be distant background.

It will be appreciated that the processing required to generate data for storage in the 3D model store 24 will depend upon the precise algorithm used to determine distance data from the image 12. More specifically depending upon the choice of algorithm either suitable distance data will be generated automatically by processing the image 12 or alternatively an intermediate set of data such as for example data representing a point cloud or a wire mesh model of the surfaces of the objects 14 appearing in an image may be created. Where such an intermediate set of data is generated, in this embodiment the distance data stored in the 3D model store is derived by processing the generated data in an appropriate manner.

Thus for example where the processing of an image results in the generation of a point cloud, the projection of each point in the point cloud to the reference plane is calculated and then the distance between the point and the image plane along a normal to the image plane would be determined and stored in the 3D model store 24. Similarly if the processing of image data is such to generate a 3D wire mesh model of objects appearing in the image 12, the projection of individual pixels from the image plane onto the model wire mesh surface is determined and the position of the identified projection is utilized to calculate a distance value for a pixel which is then stored in the 3D model data store 24.

Thus after processing the image 12 and any intermediate data which is generated, a matrix of values will be stored in the 3D model store 24 where each of the values indicates a calculated distance between an image plane and an object surface and where null values for pixels are stored for which no intersection with a surface could be determined.

Having generated and stored distance data for an image, the depth map generator 26 is then invoked to convert (s3) the absolute distance data stored in the 3D model store 24 into depth data for controlling the machine tool 32. The generated depth data is then stored in as data in the depth map store 28.

The distance data generated by the image processor 22 can range between values indicative of surfaces very close to an image plane of an image 12 to null values indicating that portions of an image correspond to parts of a background. In this embodiment which is arranged to generate a relief 40, the range of distances represented is first determined. The range of distances is then divided into a pre-determined number of levels and then each of the distance value for a pixel is then mapped (uniformly or non-uniformly) to an individual level. This enables a relief to be generated where the relative positioning of portions of an image is preserved even though the absolute distances are not necessarily correct. That is to say that recessed portions of a relief 40 correspond to remote objects in an image and protruding portions correspond to closer objects but that the depth of recess or protrusion need not correspond to the actual or scaled determined distances of the objects 14 in an image 12.

Thus for example, in an embodiment where the relief to be generated consisted of 20 different levels, initially the range of distances represented by the distance data would be determined. Say for example, the distance data represented values of distances from 1 to 5 meters. The 4 meter range would then be divided into 20 levels each corresponding to a separate 20 cm range of distances. The individual distance measurements would then be mapped to a depth value from 1-20 based on the estimated distance data determined for the different parts of the image with all measurements within the same 20 cm range being assigned the same depth value. Thus for example in such a system all points associated with the distance measurements corresponding to 1 to 1.20 meters would be assigned a value of 20 whereas points associated with distance data corresponding to 4.80 to 5 meters being assigned a value of 1. The remaining pixels for which null values were stored would then be assigned a value of 0 indicative of their being background elements.

Thus in this way the distance values are converted into depth data where the continuous distance values are quantized into discrete values. It will be appreciated that in this example the conversion of distance data to depth data is such to preserve the relative sizes of the distances determined from an image and the corresponding size of associated depth data.

This enables the machine tool in this embodiment generate a relief for which such measurements are maintained. It will be appreciated however, that in some other embodiments rather than dividing the detected distances into equal sections, the ranges of distances may be divided unequally. In particular, in some embodiment different sizes of ranges may be used for example to generate data for ground objects and background objects. Thus for example in some embodiments the discrete distance bands individual values of depth data represent in the case of foreground objects may be smaller than the distance bands utilized to convert distances corresponding to more remote objects.

Having converted the absolute distance data into depth data indicative of a set number of different depths, in this embodiment, the depth data is analyzed (s4) to identify any errors in the depth data which may have arisen in the course of image processing. More specifically, as the depth data is indicative of relative depths of a number of physical objects, it would be expected that pixels associated with particular distances would be adjacent other pixels corresponding to the same object which will be associated with similar depth values. Thus by comparing the depth value associated with a pixel to the depth values associated with all pixels in the image with a neighborhood of pixels with similar colorings, any outliers may be identified. In this embodiment two pixel neighborhoods are deemed more similar the smaller the sum of the squared Euclidean distances is between the red, green and blue color values of corresponding pixels in that neighborhood. Where such outliers are identified the pixels associated with very different depth values to pixels with similar neighborhoods would be assigned a value based on the values associated with those pixels with similar neighborhoods. In other embodiments statistical approaches could be used to determine whether calculated depth data is plausible given depth data determined for other portions of an image.

Processing data in this way not only corrects the depth data where the image processing assigned an erroneous distance to a particular pixel but also enables those pixels which are assigned null values but which actually represent portions of an object to be assigned a more accurate depth value. It will be appreciated that the actual size of pixel neighborhood which should be considered when processing the depth data in this way would depend upon the type of image being processed. Similarly the difference between the depth value for a pixel and the depth values for pixels with similar neighborhoods which prompt consideration for correction and amendment will also depend upon the variance of the depth values detected over the image for matching pixel neighborhoods and the type of image being processed.

The depth data is further processed to detect pixel regions where the relative depth difference between an adjacent region is above a pre-determined threshold. Such regions would occur when objects in the image are significantly closer to the image plane than its surroundings, making for a pronounced extrusion in the resulting relief. The coloring of the steep ramp between two disparate regions is taken as the average color of the adjacent pixels between the two regions. This can result in a stretching effect of the coloring so texture synthesis techniques such as L. Wei. L.-Y.; M. Levoy (2000); Fast texture synthesis using tree-structured vector quantization ; SIGGRAPH '00: Proceedings of the 27th annual conference on Computer graphics and interactive techniques. ACM Press/Addison-Wesley Publishing Co. (2000), 479-488 which is hereby incorporated by reference, can be used as a hole filling mechanism to synthesize a undistorted and suitable color pattern along the surface of the steep ramp.

Thus at this stage, having processed the depth data stored in the depth map store 28, the computer 15 will have determined for an image 12 data associating pixels in the image with depths indicative of ranges of distance. Having stored this data the machine controller 30 is then invoked. The machine controller 30 then (s5) generates control instructions to cause the machine tool 32 to form a relief 40 where the depth of portions of the relief 40 correspond to the depth data in the depth map store and individual portions of the relief are colored based on the color information from the original received image 12 in the input buffer.

The exact processing undertaken by the machine tool 32 and the instructions sent by the machine controller 30 will depend upon the nature and characteristics of the machine tool 32.

In one embodiment, the machine tool 32 could be arranged to form an appropriately colored relief 40 by vacuum molding. In such an embodiment the machine tool could be arranged to print an image corresponding to the image 12 in the input buffer 20 on one surface of a sheet to be vacuum formed. The machine tool could then deform the sheet to create the relief 40 by deforming different portions of the sheet to different extents depending upon the depth data in the depth map store 28.

Alternatively the machine tool 32 could be a 3D printer arranged to print a series of layers of images where each pixel in an image was printed in a color corresponding to the corresponding pixel in the image 12 in the input buffer 20 where a the number of layers where a pixel is printed is indicated by the depth data for that pixel in the depth map store 28. Thus in such an example a pixel corresponding to background portions would be printed once whereas points associated with high values of depth data would be printed many times and hence would have a greater thickness in the resulting relief 40.

A further example of a suitable machine tool 32 would be a machine tool which utilized the data in the depth map store 28 to determine depths of carving from a blank to create a relief 40 with a surface corresponding to the data in the depth map store 28. Once a suitable relief had been carved by the machine tool 32 a copy of the image in the input buffer 20 could then be printed onto the carved surface to create the finished relief 40.

### Second Embodiment

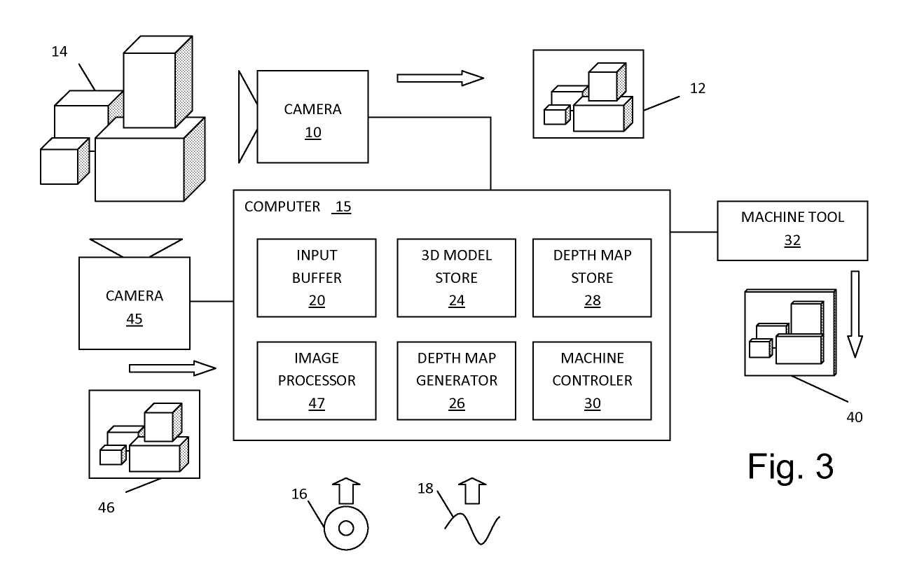

A second embodiment of the present invention will now be described with reference to FIG. 3.

In the first embodiment, a modeling apparatus was described where a single image 12 of one or more objects 14 is obtained and processed to generate a relief 40 where the height of portions of the relief are determined by estimated distances of the objects in the image 12. In contrast in this embodiment rather than processing a single image taken by a camera 10 a second camera 45 is provided which is arranged to take an image 46 of the objects 14 from a second viewpoint. This second image 46 is then passed to the input buffer 20 where both the image 12 taken by the first camera 10 and the image 46 taken by the second camera 45 are processed by a modified image processor 47 to generate model data for storage in a 3D model store 24. Other than the modified processing by the modified image processor 47, the processing undertaken by the modeling apparatus in this embodiment is identical to that of the previous embodiment and in FIG. 3 identical portions of the apparatus are indicated by the same reference numerals as in FIG. 1.

The addition of a second camera 45 viewing objects from a second viewpoint provides the modeling apparatus with additional information about the shapes of the imaged objects 14 and thus increases the available techniques which could be utilized to determine model data for storage in the 3D model store 24.

Thus for example in addition to the techniques described in relation to the first embodiment, where multiple images of objects 14 are obtained model data could be generated based on binocular disparity identified through correlation-based or feature-based correspondence and triangulation such as is described in Trucco, E; Verri, A (1998) “Introductory Techniques for 3-D Computer Vision”, Chapter 7, Prentice Hall and Scharstein, D.; Szeliski, R. (2002) “A Taxonomy and Evaluation of Dense Two-Frame Stereo Correspondence Algorithms”, International Journal of Computer Vision 47 (1/2/3), 7-42. Alternatively defocusing techniques such as local image decomposition using the Hermite polynomial basis, inverse filtering or S-Transforms as described in Ziou, D; Wang, S; Vaillancourt, J (1998) “Depth from Defocus using the Hermite Transform”, Image Processing, ICIP 98, Proc. International Conference on Volume 2, 4-7, Page(s): 958-962. , Pentland, A. P. (1987) “Depth of Scene from Depth of Field”, IEEE Transactions on Pattern Analysis and Machine Intelligence, Vol. 9, No. 4, Page(s) 523-531 and Subbarao, M.; Surya, G. (1994) “Depth from Defocus: A Spatial Domain Approach”, the International Journal of Computer Vision, 13(3), Page(s) 271-294 could be used. Alternatively a voxel-based approach based on silhouette extraction such as is described in Matsuyama, T. (2004) “Exploitation of 3D video technologies”, Informatics Research for Development of Knowledge Society Infrastructure, ICKS 2004, International Conference, Page(s) 7-14 could be used. Supervised learning methods could alternatively be used, such as that described in US2008/137989 all of which are hereby incorporated by reference.

It will be appreciated that in this embodiment, providing multiple cameras 10, 45 enables images of objects 14 to be obtained simultaneously or substantially simultaneously from two different viewpoints and for the relative positions of those viewpoints to be fixed. As the relative positioning of the viewpoints can be fixed this can assist with the identification of corresponding portions of images and hence the generation of model data for representing the surfaces of objects in the 3D model store 24.

It will be appreciated that although in the described embodiment two cameras are described as being used, in other embodiments more cameras might be utilized. Alternatively rather than using multiple cameras 10,45 in other embodiments a single camera might be utilized to obtain image data from multiple viewpoints and that image data could then be utilized to generate model data. In such an alternative embodiment where only a single camera was utilized to obtain images from multiple viewpoints the relative locations of the different viewpoints would need to be determined and standard techniques exist to achieve such an identification of relative position from a pair of images.

### Third Embodiment

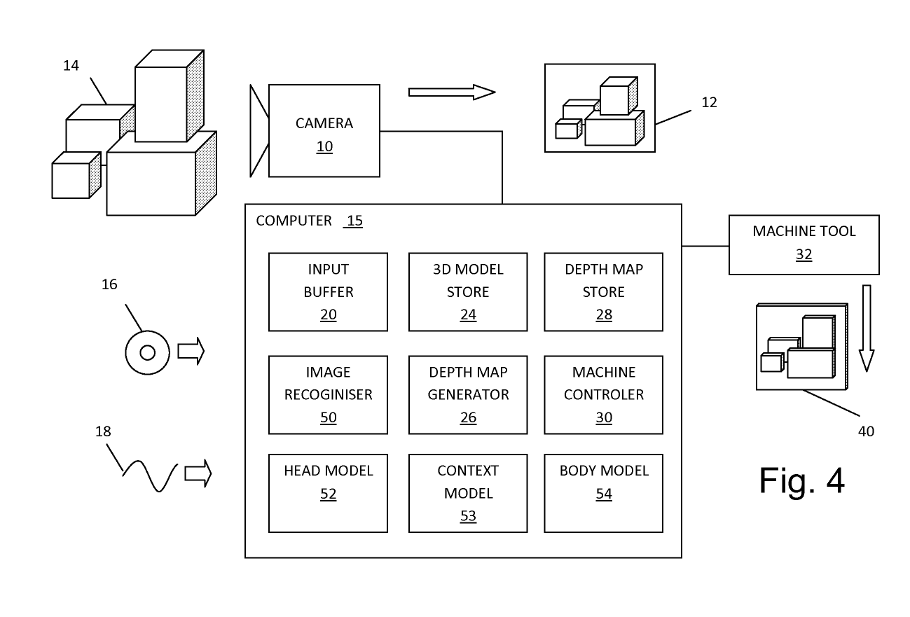

A third embodiment of the present invention will now be described with reference to FIG. 4. As with the previous embodiment like reference numbers identify like portions of the apparatus described in the previous embodiments and these portions will not be described again.

In the previous embodiments a modeling apparatus has been described which is capable of generating model representation of any image. One implementation of the present invention would be to utilize the described modeling system to generate mementos or keepsakes for visits to theme parks. In such a context, it is known to provide cameras to obtain pictures of patrons using particular rides. The present invention could be utilized to create similar 3D relief models of such events.

In the case of a camera obtaining images of patrons on a ride, as the camera is triggered by a car passing a particular part of the ride much of an image taken on one occasion will resemble that taken on another occasion. Thus for example when taking images of a rollercoaster ride from a particular location much of the image such as the location of the car, the safety restraints and the structure of the rollercoaster itself will be identical in every case. However certain aspects of each image will differ. In particular the faces of the individuals, the orientation of heads and arms etc. may change.

In the present embodiment which is intended for use in such a known fixed location, the programming of the computer 15 is modified to take advantage of the knowledge of the context in which an image is obtained to generate appropriate depth data. More specifically, in this embodiment the image processor 22, 47 of the previous embodiments is replaced by an image recognizer 50 operable to analyze portions of an image to identify the presence people and their positioning; a head model 52 for modeling surfaces corresponding to heads, a context model 53 storing three dimensional model data for a background scene; and a body model 54 for modeling surfaces corresponding to bodies and limbs.

In this embodiment as in the previous embodiments an image 12 of an object 14 is obtained and stored in the input buffer 20. However, in this embodiment, the objects 14 in question would comprise an image of a predefined object from a known location where most of the scene in question is fixed e.g. a image of individuals riding on a rollercoaster viewed from a particular viewpoint.

As the context and viewpoint of the image is known it can be established in advance that certain portions of the image e.g. the position of the car, the ride etc will be unvarying. In addition the context of the image will also indicate to the computer 15 the possible locations of individuals who may be seated in the cars of the roller coaster. When an image is received and stored, the image recognizer 50 is invoked which proceeds to analyze portions of the image where individuals may appear to determine if indeed they are present. Such an analysis would be done using standard image recognition techniques. Where individuals were identified as being present, the image recognizer 50 proceeds to invoke the head model 52 and the body model 54 to try to identify the orientation of individuals' heads and bodies in the image. Thus for example in order to determine the orientation of an individual's face the head model might attempt to identify the locations of an individual's eyes and nose etc. The head model 52 would then proceed to generate a three dimensional wire mesh model of that portion of the image using a pre-stored model representation adapted to fit the orientation of the individual in the image. A method such as that described in V. Blanz; T. Vetter (1999); A Morphable Model for the Synthesis of 3D Faces; SIGGRAPH '99 Conference Proceedings which is hereby incorporated by reference; could be used to generate a high-fidelity 3D head model. Similar processing would then be undertaken to determine and orientate models of identified individuals using the body model 54. For other known objects in the image, we can use an example-based synthesis approach such as T. Hassner; R. Basri (2006); Example Based 3D Reconstruction from Single 2D Images; IEEE Conference on Computer Vision and Pattern Recognition 2006; which is hereby incorporated by reference and which uses a database of known objects containing example patches of feasible mappings from the appearance to the depth of each object. Given an image of a novel object, the known depths of patches from similar objects are combined to produce a plausible depth estimate.

Having generated representations of the individuals in the image 12, the models of individuals are then combined with a static context model 53 representing the static portions of the scene. Thus in this way a complete model representation of the entire image is generated where the static portions of the model are derived from a pre-stored context model 53 and the variable elements are derived by adjusting head and body models 52, 54 based on an analysis of the obtained image. This complete model representation is then utilized to generate distance data which is stored in the 3D model store 24 and then processed in a similar way to the previous embodiments.

### Modifications and Amendments

In the above embodiments a determination of distances of objects relative to an image plane corresponding to the projected image plane for an image has been described. It will be appreciated that other reference planes could be utilized. It will further be appreciated that in some embodiments distance data could be determined relative to a non-planar surface.

Such embodiments would be particularly applicable to the determination of reliefs for corresponding non-planar surfaces. Thus for example a relief model on might be created on the surface of a drinking vessel such as a mug wherein the determination of relative depth values was made relative to a curved surface corresponding the outer surface of the vessel.

Although in the above embodiments a system has been described in which pixels for which no depth data can be determined are assumed to correspond to background portions of an image, it will be appreciated that other approaches could be utilized. Thus for example rather than determining distance data directly for the entirety of an image, an image could be pre-processed using conventional techniques to determine which portions of an image correspond to objects and which correspond to background. Portions of an image identified as corresponding to background portions of the image could then be assigned a background value. The remaining portions of the image could then be processed to determine distance values. Depth data for any portions of an image which were identified as corresponding to an object for which depth data could not be determined directly could then be interpolated using the depth data for other portions of those objects.

Although in the first embodiment a system has been described in which distance data is used to assign a discrete depth value for each portion of an image, it will be appreciated that is some embodiments rather than assigning discrete values a mapping function could be utilized to convert distance data into relative depth data. In such an embodiment using a mapping function would enable a smoother variation of depths for a relief model to be determined.

Although in the above embodiments reference has been made to the utilization of image data to determine the appropriate color of portions of a relief model, it will be appreciated that the image data may be processed or filtered prior to use. Such processing could include effects such as rendering an image as a sepia or gray scale image as well as retouching an image or the application of appropriate artistic effects prior to the use of the image data to determine color for a generated relief model.

Although in the above embodiments reference has been made to the imaging of objects, it will be appreciated that such objects need not necessarily correspond to physical objects and would encompass any suitable visual element in an image such as clouds, mist, lightning or rainbow effects etc.

In the embodiments described in detail approaches have been described in which distance or depth data is determined by processing an image which is then utilized to color a manufactured relief. It will be appreciated that in some embodiments depth or distance data could be determined using other methods. Thus for example where the shape of an object is known in advance image data could be processed to identify the object and the orientation of an object in the image and that information could be used to determine appropriate depth data. In an alternative approach the shape of an image could be determined using conventional techniques such as through laser scanning or the use of structured light to determine an appropriate depth map with the depth map being scaled appropriately to create a relative depth map for the purposes of generating a relief model.

In the present application a number of different approaches to determining depth or distance data for objects in an image have been described. It will be appreciated that multiple different approaches to determining depth or distance data could be combined to determine data for a particular image. Where multiple approaches were combined either different approaches could be utilized for different parts of an image or alternatively multiple approaches could be utilized to generate depth data for the same part of an image with the determined values obtained using different approaches being compared and combined.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A computer implemented relief model generation method comprising:
obtaining image data representing an image of one or more objects from a viewpoint;
determining relative depths of portions of objects appearing in the image as viewed from the viewpoint;
assigning portions of the image depth data on the basis of said determination of relative depths;
controlling a machine tool utilizing the assigned depth data to generate a three dimensional relief of the obtained image; and
coloring the generated relief using the obtained image data.

2. A relief model generation method in accordance with claim 1 wherein determining relative depths of portions objects appearing in an image comprises:
processing obtained image data to generate a three dimensional computer model of objects in the image; and
utilizing the generated three dimensional computer model to determine the relative depths of portions objects appearing in the image as viewed from the viewpoint.

3. A relief model generation method in accordance with claim 2, wherein processing obtained image data to generate a three dimensional computer model of objects in the image comprises:
storing a three dimensional computer model of objects corresponding to a least part of the obtained image; and
utilizing the stored computer model to assign depth data to the portions of the image corresponding to the stored computer model.

4. A relief model generation method in accordance with claim 3, further comprising:
identifying portions of an obtained image which do not correspond to the stored three dimensional computer model;
generating a three-dimensional computer model of the portions of an obtained image which do not correspond to the stored three dimensional computer model; and
utilizing the generated computer model to assign depth data to the generated computer model.

5. A relief model generation method in accordance with claim 1 wherein determining relative depths of portions of objects appearing in an image comprises:
obtaining image data of the one or more objects appearing in an image from a plurality of viewpoints; and
utilizing said image data of the one or more objects appearing in an image from a plurality of viewpoints to generate a three-dimensional model of one or more objects appearing in an image.

6. A relief model generation method in accordance with claim 1 wherein determining relative depths of portions of objects appearing in an image comprises determining the distance between the portions of objects appearing in an image and a viewpoint and assigning portions of the image depth data on the basis of said determined distances.

7. A relief model generation method in accordance with claim 6 wherein assigning portions of the image depth data on the basis of said determined distances comprises assigning the same depth data to all portions of an image determined to be in specified ranges of distances from the viewpoint.

8. A modeling apparatus comprising:
an input buffer operable to receive image data representing an image of one or more objects from a viewpoint;
an image processor operable to determine relative depths of portions objects appearing in the image as viewed from the viewpoint;
a depth map generator operable to assign portions of an image, depth data on the basis of relative depths determined by the image processor; and
a controller operable to generate instructions to control a machine tool to generate a three dimensional relief of an image on the basis of depth data assigned to portions of an image by the depth map generator and color the generated relief utilizing received image data.

9. A modeling apparatus in accordance with claim 8 wherein the image processor is operable to:
process obtained image data to generate a three dimensional computer model of objects in the image; and
utilize the generated three dimensional computer model to determine the relative depths of portions of objects appearing in the image as viewed from the viewpoint.

10. A modeling apparatus in accordance with claim 9, further comprising:
a context stored operable to storing a three dimensional computer model of objects corresponding to a least part of the obtained image, wherein said image processor is operable to utilize the stored computer model to assign depth data to the portions of the image corresponding to the stored computer model.

11. A modeling apparatus in accordance with claim 10, further comprising:
an image recognizer operable to identify portions of an obtained image which do not correspond to the stored three dimensional computer model wherein the image processor is operable to generate a three-dimensional computer model of the portions of an obtained image which do not correspond to the stored three dimensional computer model; and utilize the generated computer model to assign depth data to the generated computer model.

12. A modeling apparatus in accordance with claim 8 further comprising a plurality of cameras operable to obtaining image data of the one or more objects from a plurality of viewpoints; wherein said image processor is operable to utilize said image data of the one or more objects appearing in an image from a plurality of viewpoints to generate a three-dimensional model of one or more objects appearing in an image.

13. A modeling apparatus in accordance with claim 8 wherein said depth map generator is operable to determine relative depths of portions objects appearing in an image by determining the distance between of portions of objects appearing in an image and a viewpoint and assigning portions of the image depth data on the basis of said determination determined distances.

14. A modeling apparatus in accordance with claim 13 wherein said depth map generator is operable to assigning portions of the image depth data on the basis of said determination determined distances comprises assigning the same depth data to all portions of an image determined to be in specified ranges of distances from the viewpoint.

15. A modeling apparatus in accordance with claim 8 further comprising a machine tool operable to form a relief on the basis of instructions generated by the controller.

16. A modeling apparatus in accordance with claim 15 wherein said machine tool comprises a machine tool selected from the group comprising: a 3D printer, a vacuum forming apparatus and an automated carving apparatus.
